(19) United States
(12) Patent Application Publication
(10) Pub. No.: US 2025/0246846 A1
(43) Pub. Date: Jul. 31, 2025

(54) WATERPROOF CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Akihiro NISHITANI, Mie (JP)

(21) Appl. No.: 18/845,894

(22) PCT Filed: Feb. 22, 2023
(86) PCT No.: PCT/JP2023/006348

§ 371 Date: Sep. 11, 2024

(30) Foreign Application Priority Data
Mar. 15, 2022 (JP) 2022-039813

(51) Int. Cl. H01R 13/52

(52) U.S. Cl. CPC H01R 13/5205

(57) ABSTRACT

A waterproof connector includes a plurality of terminal fittings to be individually accommodated into a plurality of rear terminal accommodation chambers from front of a housing, a one-piece rubber plug to be mounted into a rear end part of the housing, and a plurality of wires to be accommodated into the terminal fittings mounted in the rear terminal accommodation chambers through sealing holes from behind the one-piece rubber plug. The terminal fitting is configured by assembling a first component including a flexible connecting portion capable of sandwiching the wire and a second component including a pressing portion and relatively movable in a front-rear direction between an initial position and a connection position with respect to the first component. The flexible connecting portion sandwiches the wire by being deformed by the pressing portion in the process of moving the second component from the initial position to the connection position.

### TECHNICAL FIELD

The present disclosure relates to a waterproof connector.

### BACKGROUND

Patent Document 1 discloses a waterproof connector provided with a housing including a plurality of cavities, a sealing member including a plurality of sealing holes and a plurality of terminal fittings fixed to front end parts of wires. The sealing member is mounted in a rear end part of the housing. The terminal fitting is mounted into the housing by being inserted into the housing through the sealing hole from behind the sealing member. With the terminal fitting inserted, the wire is held in close contact with the sealing hole in a liquid-tight manner to exhibit a waterproof function.

### PRIOR ART DOCUMENT

### Patent Document

Patent Document 1: JP 2013-235747 A

### SUMMARY OF THE INVENTION

### Problems to be Solved

There is a concern that the terminal fitting damages the inner peripheral surface of the sealing hole when being passed through the sealing hole. If the inner peripheral surface of the sealing hole is damaged, sealing performance is reduced.

A waterproof connector of the present disclosure was completed on the basis of the above problem and aims to prevent a reduction in the reliability of sealing performance.

### Means to Solve the Problem

The present disclosure is directed to a waterproof connector with a housing formed with a plurality of terminal accommodation chambers, a plurality of terminal fittings to be individually accommodated into the plurality of terminal accommodation chambers from front of the housing, a one-piece rubber plug mounted into a rear end part of the housing, the one-piece rubber plug including a plurality of sealing holes, and a plurality of wires to be accommodated into the terminal fittings mounted in the terminal accommodation chambers through the sealing holes from behind the one-piece rubber plug, the terminal fitting being configured by assembling a first component made of an electrically conductive material and including a flexible connecting portion capable of sandwiching the wire and a second component including a pressing portion and relatively movable in a front-rear direction between an initial position and a connection position with respect to the first component, and the flexible connecting portion sandwiching the wire by being deformed by the pressing portion in the process of moving the second component from the initial position to the connection position.

### Effect of the Invention

According to the present disclosure, it is possible to prevent a reduction in the reliability of sealing performance.

### BRIEF DESCRIPTION OF THE DRAWINGS

FIG. 1 is a perspective view showing an assembled state of a waterproof connector of an embodiment.

FIG. 2 is a perspective view showing a disassembled state of a housing, a one-piece rubber plug and a rear holder.

FIG. 3 is a perspective view showing a state where a terminal fitting and a wire are connected.

FIG. 4 is a perspective view showing a disassembled state of the terminal fitting into a first component and a second component.

FIG. 5 is a side view in section showing a connection process of the terminal fitting and the wire.

FIG. 6 is a side view in section enlargedly showing a part of FIG. 5.

FIG. 7 is a partial enlarged side view in section showing a connected state of the terminal fitting and the wire.

FIG. 8 is a side view in section showing the assembled state of the waterproof connector.

### DETAILED DESCRIPTION TO EXECUTE THE INVENTION

### Description of Embodiments of Present Disclosure

First, embodiments of the present disclosure are listed and described.

(1) The waterproof connector of the present disclosure is provided with a housing formed with a plurality of terminal accommodation chambers, a plurality of terminal fittings to be individually accommodated into the plurality of terminal accommodation chambers from front of the housing, a one-piece rubber plug mounted into a rear end part of the housing, the one-piece rubber plug including a plurality of sealing holes, and a plurality of wires to be accommodated into the terminal fittings mounted in the terminal accommodation chambers through the sealing holes from behind the one-piece rubber plug, the terminal fitting being configured by assembling a first component made of an electrically conductive material and including a flexible connecting portion capable of sandwiching the wire and a second component including a pressing portion and relatively movable in a front-rear direction between an initial position and a connection position with respect to the first component, and the flexible connecting portion sandwiching the wire by being deformed by the pressing portion in the process of moving the second component from the initial position to the connection position. According to the configuration of the present disclosure, since the terminal fitting needs not be passed through the sealing hole, the inner peripheral surface of the sealing hole is not damaged by the terminal fitting. Therefore, a reduction in the reliability of sealing performance can be prevented.

(2) Preferably, the housing includes a housing body formed with the terminal accommodation chambers and a front member for preventing the terminal fittings mounted in the terminal accommodation chambers from moving any further forward by being attached to a front end part of the housing body, the first component is relatively displaceable in the front-rear direction with respect to the housing body with a front end part of the first component projecting forward from the housing body, and the second component is moved between the initial position and the connection position integrally with the housing body. According to this configuration, it is possible to grasp a relative positional relationship of the second component with respect to the first component and, consequently, detect whether or not the wire and the terminal fitting are connected by detecting a relative positional relationship between the housing body and the first component.

(3) Preferably, in (2), the wire is accommodated inside the first component, and the first component is formed with a detection hole for enabling a part accommodated in the first component, out of the wire, to be visually observed from outside of the housing body. According to this configuration, it can be detected whether or not the terminal fitting and the wire are connected in a proper positional relationship.

(4) Preferably, a movement restricting portion for restricting a relative rearward movement of the terminal fitting is formed in the terminal accommodation chamber. According to this configuration, the terminal fitting can be held at a proper position in the terminal accommodation chamber even if the housing body is not formed with a locking lance.

(5) Preferably, the flexible connecting portion is formed with a biting portion, the wire biting into the biting portion. According to this configuration, the connection reliability of the flexible connecting portion and the wire is improved.

(6) Preferably, the flexible connecting portion is formed with a compressing portion for sandwiching the wire in a bent state. According to this configuration, the connection reliability of the flexible connecting portion and the wire is improved.

### Details of Embodiment of Present Disclosure

### Embodiment

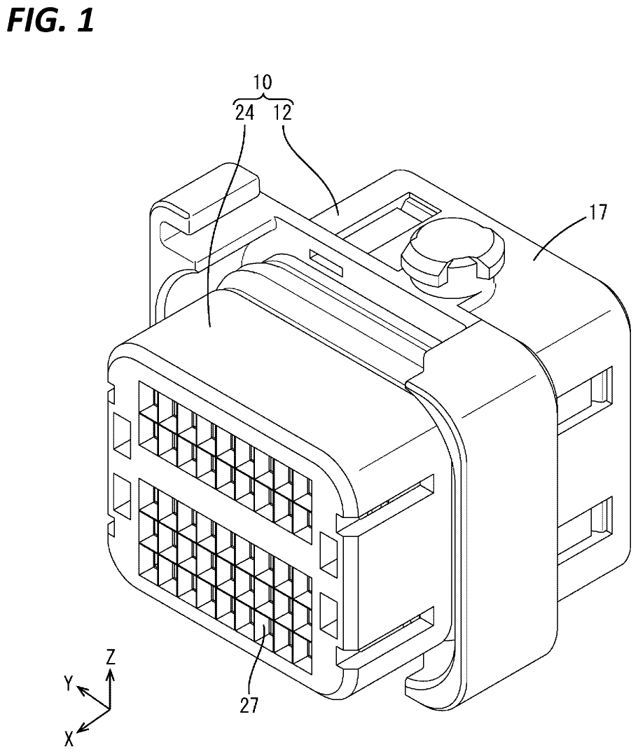

A waterproof connector of one specific embodiment of the present disclosure is described below with reference to FIGS. 1 to 8. The present disclosure is not limited to these illustrations, but is represented by claims and intended to include all changes in the scope of claims and in the meaning and scope of equivalents. In this embodiment, a positive direction of an X axis in FIGS. 1 to 8 is defined as a forward direction concerning a front-rear direction. A positive direction of a Y axis in FIGS. 1 to 4 is defined as a rightward direction concerning a lateral direction. A positive direction of a Z axis in FIGS. 1 to 8 is defined as an upward direction concerning a vertical direction.

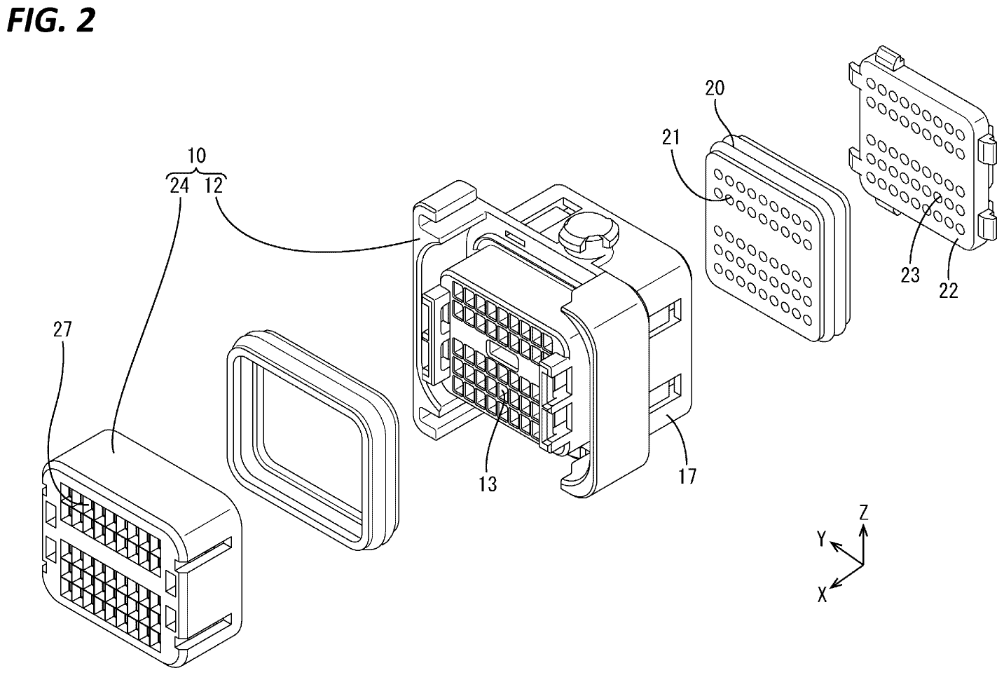

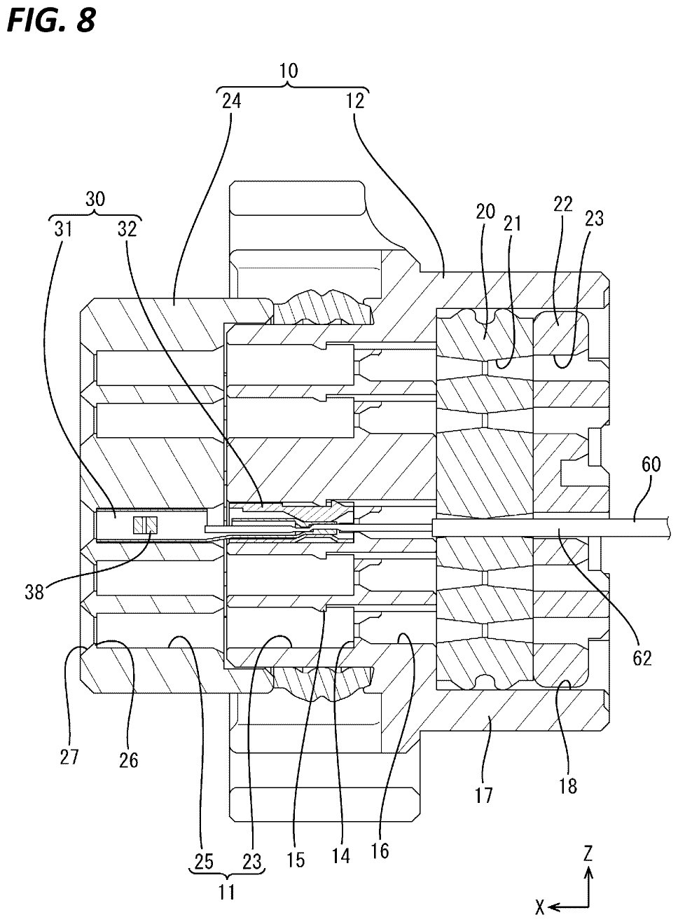

The waterproof connector of this embodiment is, as shown in FIGS. 2 and 8, provided with one housing 10, one one-piece rubber plug 20, one rear holder 22, a plurality of terminal fittings 30 and a plurality of wires 60 individually connected to the plurality of terminal fittings 30. The one-piece rubber plug 20 is mounted in a rear end part of the housing 10, and the rear holder 22 is assembled behind the one-piece rubber plug 20. The plurality of terminal fittings 30 are accommodated into a plurality of terminal accommodation spaces 11 formed in the housing 10. The wire 60 is such a known cable that a single core wire 61 is surrounded by an insulation coating 62. The wire 60 connected to the terminal fitting 30 is drawn out rearward of the housing 10 through the one-piece rubber plug 20 and the rear holder 22. The one-piece rubber plug 20 prevents water intrusion from behind the housing 10.

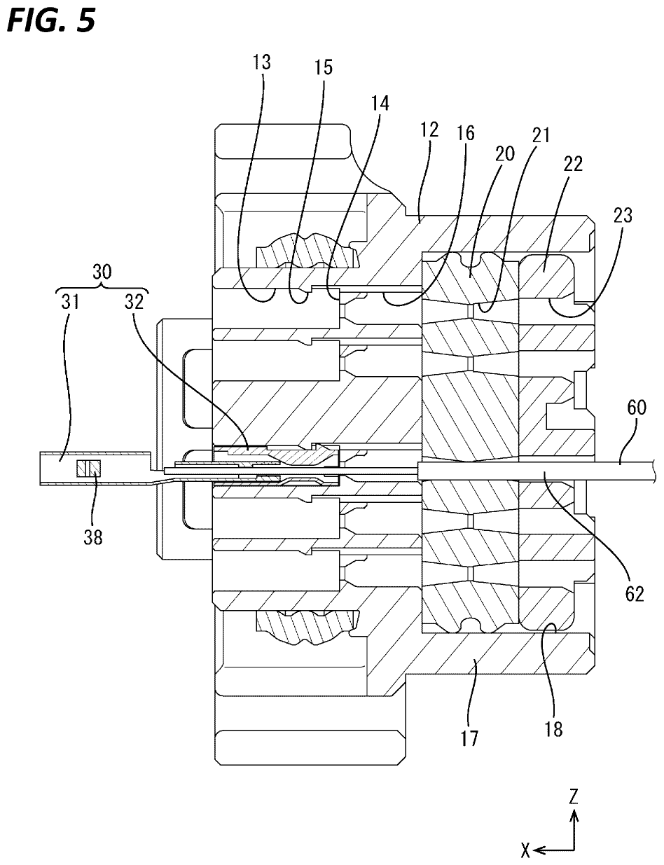

The housing 10 is configured by assembling a housing body 12 made of synthetic resin and a front member 24 made of synthetic resin. A plurality of rear terminal accommodation chambers 13 are formed inside the housing body 12. As shown in FIG. 5, the rear terminal accommodation chamber 13 is open in the front surface of the housing body 12. As shown in FIGS. 5 and 8, a movement restricting portion 14 is formed in a rear end part of the rear terminal accommodation chamber 13. A temporary locking projection 15 is formed at a position in front of the movement restricting portion 14 in the rear terminal accommodation chamber 13. A plurality of wire insertion chambers 16 are formed inside the housing body 12. The plurality of wire insertion chambers 16 are located behind the plurality of rear terminal accommodation chambers 13 and open in the rear surface of the housing body 12. The rear ends of the plurality of rear terminal accommodation chambers 13 and the front ends of the plurality of wire insertion chambers 16 individually communicate in the front-rear direction.

A peripheral wall portion 17 in the form of a rectangular tube projecting rearward from the outer peripheral edge of the housing body 12 is formed in a rear end part of the housing body 12. The one-piece rubber plug 20 is accommodated in a sealing space 18 surrounded by the peripheral wall portion 17. The one-piece rubber plug 20 is formed with a plurality of sealing holes 21 penetrating through the one-piece rubber plug 20 in the front-rear direction. The front ends of the plurality of sealing holes 21 and the rear ends of the plurality of wire insertion chambers 16 individually communicate in the front-rear direction. The rear holder 22 for preventing the one-piece rubber plug 20 from coming out rearward from the housing 12 is mounted in the sealing space 18. The rear holder 22 is formed with a plurality of wire through holes 23 individually communicating with the rear ends of the plurality of sealing holes 21.

The front member 24 is attached to the housing body 12 to cover the front surface of the housing body 12. The front member 24 is formed with a plurality of front terminal accommodation chambers 25. The front terminal accommodation chambers 25 are open in the rear surface of the front member 24. A front stop portion 26 is formed in a front end part of the front terminal accommodation chamber 25. A plurality of tab insertion holes 27 individually communicating with the front end parts of the plurality of front terminal accommodation chambers 25 are formed in the front surface of the front member 24.

The housing 10 is configured by mounting the one-piece rubber plug 20, the rear holder 22 and the front member 24 to the housing body 12. The front terminal accommodation chamber 25, the rear terminal accommodation chamber 13, the wire insertion chamber 16, the sealing hold 21 and the wire through hole 23 are arranged in line in the front-rear direction. The terminal accommodation space 11 for accommodating the terminal fitting 30 is constituted by the front terminal accommodation chamber 25 and the rear terminal accommodation chamber 13.

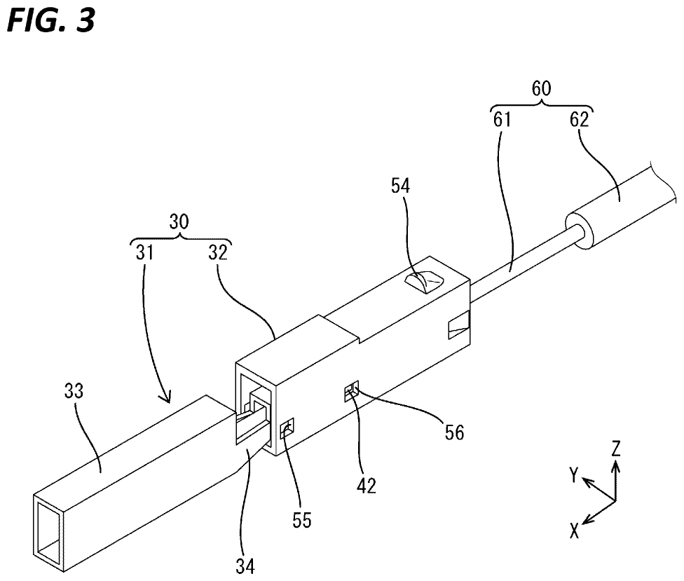

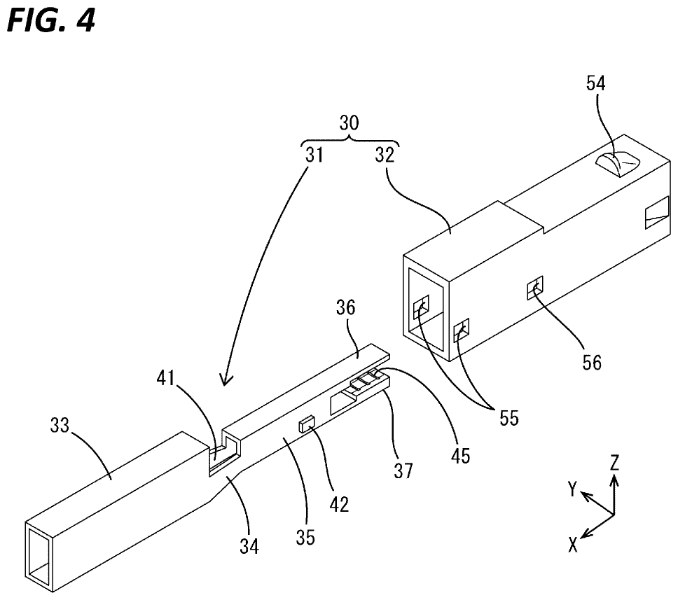

As shown in FIG. 3, the terminal fitting 30 has a shape elongated in the front-rear direction as a whole. As shown in FIG. 4, the terminal fitting 30 is configured by assembling a first component 31 and a second component 32. The first component 31 is formed, such as by bending a metal plate material stamped into a predetermined shape, and has a shape elongated in the front-rear direction as a whole. The first component 31 includes a tab connecting portion 33, a linking portion 34, a supporting portion 35 and a pair of upper and lower flexible connecting portions 36, 37. The tab connecting portion 33 is in the form of a rectangular tube open on both front and rear ends. The linking portion 34 projects rearward from the rear end of the tab connecting portion 33. The supporting portion 35 is in the form of a rectangular tube and extends rearward from the rear end of the linking portion 34. The flexible connecting portions 36, 37 are cantilevered rearward from the rear end of the supporting portion 35. A resilient contact piece 38 (see FIGS. 5 and 8) to be brought into contact with a tab (not shown) of a mating terminal (not shown) is accommodated in the tab connecting portion 33.

The linking portion 34 is shaped such that a pair of side plate portions 40 rise from both left and right side edges of a bottom plate portion 39. An opening in the upper surface of the linking portion 34 functions as a detection hole 41 for confirming the presence of the wire 60. Holding projections 42 are formed on both left and right outer surfaces of the supporting portion 35.

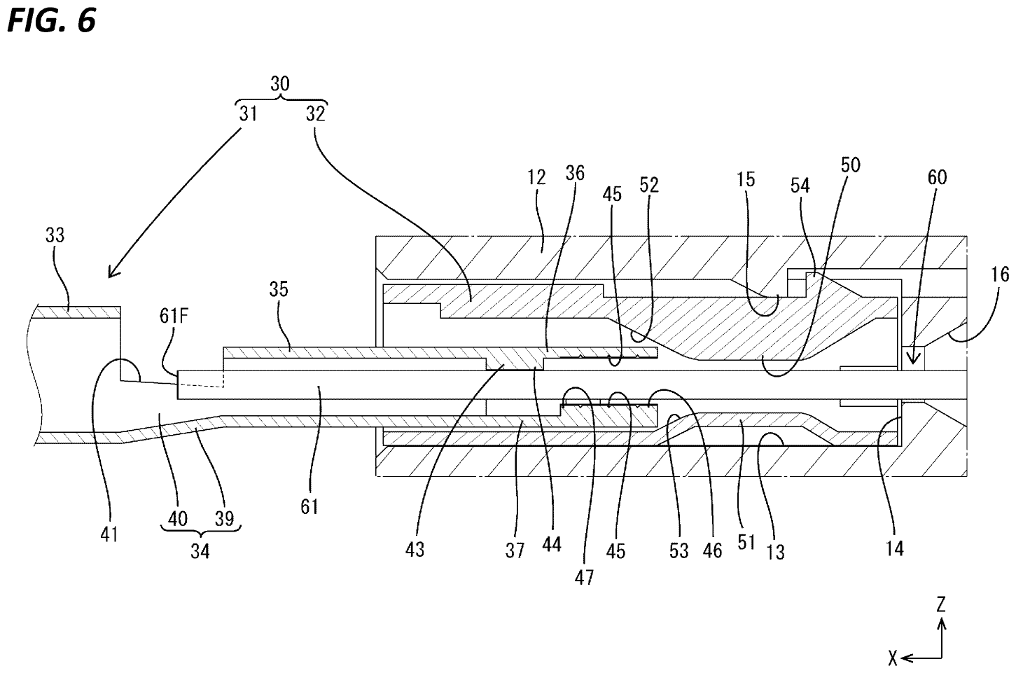

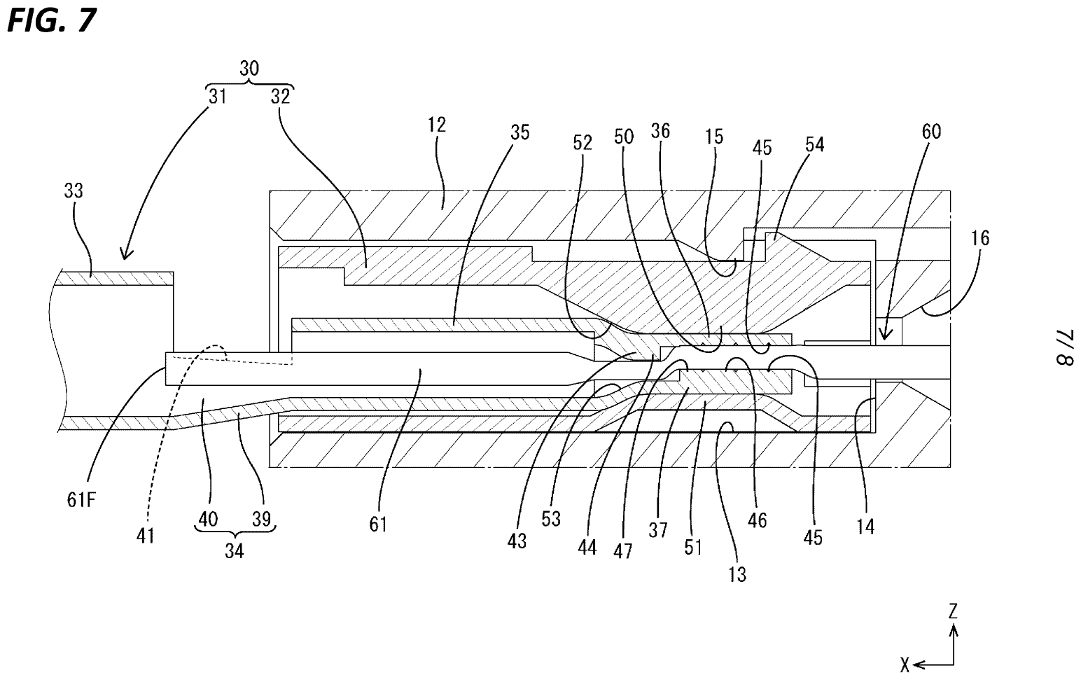

The pair of flexible connecting portions 36, 37 are in the form of plates having a plate thickness direction oriented in the vertical direction, and can be plastically or resiliently deformed in the vertical direction to come closer to each other. As shown in FIGS. 6 and 7, a front bulging portion 43 shaped to project downward toward the lower flexible connecting portion 37 is formed on a front end part of the upper flexible connecting portion 36. A stepped rear end part of the front bulging portion 43 functions as an upper compressing portion 44. A plurality of groove-like biting portions 45 extending in the lateral direction are formed in a region behind the front bulging portion 43, out of the lower surface of the upper flexible connecting portion 36.

A rear bulging portion 46 shaped to project upward toward the upper flexible connecting portion 36 is formed in a rear end region of the lower flexible connecting portion 36. A stepped front end part of the rear bulging portion 46 functions as a lower compressing portion 47 located slightly behind the upper compressing portion 44. A plurality of groove-like biting portions 45 extending in the lateral direction are formed in the upper surface of the rear bulging portion 46.

The second component 32 is made of a metal material and in the form of a rectangular tube elongated in the front-rear direction and open in both front and rear end surfaces. An upper pressing portion 50 and a lower pressing portion 51 are formed inside the second component 32. The upper pressing portion 50 is shaped by causing a lower surface part of an upper wall portion constituting the second component 32 to project downward. An upper guide surface 52 inclined to be gradually higher toward the front is formed on a front end part of the upper pressing portion 50. The lower pressing portion 51 is shaped by causing a lower wall portion constituting the second component 32 to project upward. A lower guide surface 53 inclined to be gradually lower toward the front is formed on a front end part of the lower pressing portion 51.

A retaining projection 54 is formed on the upper surface of the second component 32. Initial position locking holes 55 and connection position locking holes 56 are formed in a pair of left and right side wall portions constituting the second component 32. The initial position locking holes 55 are arranged in a front end part of the second component 32. The connection position locking holes 56 are arranged behind the initial position locking holes 55.

Next, an assembly procedure of the waterproof connector of this embodiment is described. The one-piece rubber plug 20 and the rear holder 22 are mounted into the sealing space 18 of the housing body 12. For the terminal fitting 30, a rear end part of the first component 31 is inserted into the front end part of the second component 32 and the holding projections 42 are fit into the initial position locking holes 55. By the locking action of the holding projections 42 and the initial position locking holes 55, the second component 32 is held at an initial position with respect to the first component 31. With the second component 32 located at the initial position, a rear end part of the supporting portion 35 and the entire upper and lower flexible connecting portions 36, 37 are accommodated in the second component 32 as shown in FIG. 6. The rear ends of the upper and lower flexible connecting portions 36, 37 are located slightly in front of the upper and lower guide surfaces 52, 53. In a front end part of the wire 60, the insulation coating 62 is removed to expose the single core wire 61.

Subsequently, the terminal fitting 30 is inserted into the rear terminal accommodation chamber 13 from front of the housing body 12. With the terminal fitting 30 inserted in the rear terminal accommodation chamber 13, the rear end of the second component 32 can face and be lockable to the movement restricting portion 14 from front, and the retaining projection 54 of the second component 32 can be lockable to the temporary locking projection 15 of the rear terminal accommodation chamber 13 from behind. The terminal fitting 30 is held mounted in the housing body 12 by the locking action of the movement restricting portion 14 and the temporary locking projection 15. In this state, the entire second component 32 is accommodated in the rear terminal accommodation chamber 13. Out of the first component 31, a rear end part of the supporting portion 35, the entire upper flexible connecting portion 36 and the entire lower flexible connecting portion 37 are accommodated in the rear terminal accommodation chamber 13 and the second component 32. Out of the first component 31, the entire tab connecting portion 33, the entire linking portion 34 and the front end part of the supporting portion 35 project forward from the front surface of the housing body 12 and are exposed.

Before or after the terminal fitting 30 is mounted into the housing body 12, the wire 60 is inserted into the housing body 12 from behind the rear holder 22. The wire 60 is successively inserted into the wire through hole 23 of the rear holder 22, the sealing hole 21 of the one-piece rubber plug 20, the wire insertion chamber 16 of the housing body 12 and the rear terminal accommodation chamber 13. In a plan view of the terminal fitting 30, an inserting operation of the wire 60 is completed when a front end 61F of the single core wire 61 reaches the inside of an opening region of the detection hole 41. A part of the wire 60 where the insulation coating 62 covers the single core wire 61 is held in close contact with the inner peripheral surface of the sealing hole 21 in a liquid-tight manner. Only an exposed part of the single core wire 61 of the wire 60 is accommodated inside the terminal fitting 30. The single core wire 61 is inserted between the upper and lower pressing portions 50, 51 and between the upper and lower flexible connecting portions 36, 37.

The linking portion 34 formed with the detection hole 41 is exposed outside the housing body 12. Therefore, whether or not the front end 61F of the single core wire 61 is located in the opening region of the detection hole 41 can be confirmed by viewing the terminal fitting 30 from above or by a camera or the like (not shown).

Subsequently, with the first component 31 fixed by a jig (not shown), the second component 32 is moved relatively forward with respect to the first component 31. When the second component 32 is relatively moved, the housing body 12, the one-piece rubber plug 20, the rear holder 22 and the wire 60 are integrally moved forward and the second component 32 is pushed from behind by the movement restricting portion 14. When the second component 32 reaches the connection position, the connection position locking holes 56 and the holding projections 42 are fit and the second component 32 is held at the connection position by this fitting.

In the process of moving the second component 32 to the connection position, the upper guide surface 52 of the upper pressing portion 50 deforms the upper flexible connecting portion 36 downward and the lower guide surface 53 of the lower pressing portion 51 deforms the lower flexible connecting portion 37 upward. With the second component 32 moved to the connection position, the upper flexible connecting portion 36 pressed downward by the upper pressing portion 50 and the lower flexible connecting portion 37 pressed upward by the lower pressing portion 51 vertically compress the single core wire 61. In this way, the single core wire 61 and the first component 31 are conductively connected.

The single core wire 61 bites into the biting portions 45 of the upper flexible connecting portion 36 and the biting portions 45 of the lower flexible connecting portion 37. By this biting, the single core wire 61 is held in a state where the single core wire 61 is prevented from relatively moving in the front-rear direction with respect to the first component 31. In front of the biting portions 45, the single core wire 61 is sandwiched in a state bent into a step shape between the upper and lower compressing portions 44, 47. Also by this sandwiching, the single core wire 61 is held in the state where the single core wire 61 is prevented from relatively moving in the front-rear direction with respect to the first component 31. In the above way, the connection of the wire 60 and the terminal fitting 30 is completed.

After the wires 60 and the terminal fittings 30 are connected, the front member 24 is assembled with the front end part of the housing body 12. If the front member 24 is assembled, the assembly of the housing 10 is completed. With the housing 10 assembled, the rear terminal accommodation chambers 13 and the front terminal accommodation chambers 25 are arranged to communicate in the front-rear direction, whereby the terminal accommodation spaces 11 are configured and the entire terminal fittings 30 are accommodated in the terminal accommodation spaces 11. The terminal fittings 30 are held in a state where the terminal fittings 30 are prevented from relatively moving forward with respect to the housing 10 by the front stop portions 26 in the front end parts of the front terminal accommodation chambers 25. In the above way, the assembly of the waterproof connector is completed.

The waterproof connector of this embodiment includes the housing 10, the plurality of terminal fittings 30, the one-piece rubber plug 20 and the plurality of wires 60 as shown in FIGS. 1 and 2. The plurality of terminal fittings 30 are individually accommodated into a plurality of the rear terminal accommodation chambers 13 from front of the housing 10. The one-piece rubber plug 20 includes the plurality of sealing holes 21 and mounted into the rear end part of the housing 10. The plurality of wires 60 are passed through the sealing holes 21 from behind the one-piece rubber plug 20, and accommodated into the terminal fittings 30 accommodated in the terminal accommodation spaces 11.

The terminal fitting 30 is configured by assembling the first component 31 and the second component 32. The first component 31 is made of an electrically conductive material and includes the pair of upper and lower flexible connecting portions 36, 37 capable of sandwiching the single core wire 61 of the wire 60. The second component 32 includes the upper and lower pressing portions 50, 51, and is relatively movable in the front-rear direction between the initial position and the connection position with respect to the first component 31. In the process of moving the second component 32 from the initial position to the connection position, the upper and lower flexible connecting portions 36, 37 are deformed by the upper and lower pressing portions 50, 51 and vertically sandwich the single core wire 61 of the wire 60. According to this configuration, since the terminal fittings 30 need not be passed through the sealing holes 21 of the one-piece rubber plug 20, the inner peripheral surfaces of the sealing holes 21 are not damaged by the terminal fittings 30. Therefore, a reduction in the reliability of sealing performance can be prevented.

The housing 10 is provided with the housing body 12 formed with the rear terminal accommodation chambers 13 and the front member 24 for preventing the terminal fittings 30 mounted into the rear terminal accommodation chambers 13 from moving any further forward by being attached to the front end part of the housing body 12. With the front end part of the first component 31 projecting forward from the housing body 12, the first component 31 can be relatively displaced in the front-rear direction with respect to the housing body 12. The second component 32 moves between the initial position and the connection position integrally with the housing body 12. According to this configuration, it is possible to grasp a relative positional relationship of the second component 32 with respect to the first component 31 and, consequently, detect whether or not the wire 60 and the terminal fitting 30 are connected by detecting a relative positional relationship between the housing body 12 and the first component 31.

A part of the wire 60 where the single core wire 61 is exposed is accommodated inside the first component 31. The first component 31 is formed with the detection hole 41. In the detection hole 41, the front end 61F of the single core wire 61 of the wire 60 accommodated in the first component 31 can be visually observed from the outside of the housing body 12. According to this configuration, it can be detected whether or not the terminal fitting 30 and the single core wire 61 of the wire 60 are connected in a proper positional relationship.

The movement restricting portion 14 for restricting a relative rearward movement of the terminal fitting 30 is formed in the rear terminal accommodation chamber 13. According to this configuration, the terminal fitting 30 can be held at a proper position in the rear terminal accommodation chamber 13 even if the housing 12 is not formed with a locking lance.

The upper and lower flexible connecting portions 36, 37 are formed with the biting portions 45, into which the single core wire 61 of the wire 60 bite. According to this configuration, the connection reliability of the both upper and lower flexible connecting portions 36, 37 and the single core wire 61 of the wire 60 is improved. The upper and lower flexible connecting portions 36, 37 are formed with the upper and lower compressing portions 44, 47 for sandwiching the single core wire 61 in a bent state. According to this configuration, the connection reliability of the both upper and lower flexible connecting portions 36, 37 and the single core wire 61 is improved.

### OTHER EMBODIMENTS

The present invention is not limited to the above described and illustrated embodiment, but is represented by claims. The present invention includes all changes in the scope of claims and in the meaning and scope of equivalents and also include the following embodiments.

The first component may be shaped not to include the detection hole.

The flexible connecting portion may be shaped not to include the biting portions.

The flexible connecting portion may be shaped not to include the compressing portion.

The second component may be a member made of an insulating material.

The second component may be arranged in front of the first component.

### LIST OF REFERENCE NUMERALS

10 . . . housing
11 . . . terminal accommodation space
12 . . . housing body
13 . . . rear terminal accommodation chamber (terminal accommodation chamber)
14 . . . movement restricting portion
15 . . . temporary locking projection
16 . . . wire insertion chamber
17 . . . peripheral wall portion
18 . . . sealing space
20 . . . one-piece rubber plug
21 . . . sealing hole
22 . . . rear holder
23 . . . wire through hole
24 . . . front member
25 . . . front terminal accommodation chamber
26 . . . front stop portion
27 . . . tab insertion hole
30 . . . terminal fitting
31 . . . first component
32 . . . second component
33 . . . tab connecting portion
34 . . . linking portion
35 . . . supporting portion
36 . . . upper flexible connecting portion
37 . . . lower flexible connecting portion
38 . . . resilient contact piece
39 . . . bottom plate portion
40 . . . side plate portion
41 . . . detection hole
42 . . . holding projection
43 . . . front bulging portion
44 . . . upper compressing portion
45 . . . biting portion
46 . . . rear bulging portion
47 . . . lower compressing portion
50 . . . upper pressing portion
51 . . . lower pressing portion
52 . . . upper guide surface
53 . . . lower guide surface
54 . . . retaining projection
55 . . . initial position locking hole
56 . . . connection position locking hole
60 . . . wire
61 . . . single core wire
61F . . . front end of single core wire
62 . . . insulation coating

1. A waterproof connector, comprising:
a housing including a housing body formed with a plurality of terminal accommodation chambers;
a plurality of terminal fittings to be individually accommodated into the plurality of terminal accommodation chambers from front of the housing body;
a one-piece rubber plug mounted into a rear end part of the housing body, the one-piece rubber plug including a plurality of sealing holes; and
a plurality of wires to be accommodated into the terminal fittings mounted in the terminal accommodation chambers through the sealing holes from behind the one-piece rubber plug,
the terminal fitting being configured by assembling a first component made of an electrically conductive material and including a flexible connecting portion capable of sandwiching the wire and a second component including a pressing portion and relatively movable in a front-rear direction between an initial position and a connection position with respect to the first component,
the terminal fitting being inserted into the terminal accommodation chamber from front with the second component held at the initial position,
the terminal fitting accommodated in the terminal accommodation chamber being prevented from moving any further forward by bringing the second component into contact with a movement restricting portion formed in the housing body,
the terminal fitting accommodated in the terminal accommodation chamber being restricted from coming out rearward by locking a retaining projection of the second component to a temporary locking projection formed in the terminal accommodation chamber, and
the flexible connecting portion sandwiching the wire by being deformed by the pressing portion in the process of moving the second component from the initial position to the connection position.

2. The waterproof connector of claim 1, wherein:
the housing includes a front member for preventing the terminal fittings mounted in the terminal accommodation chambers from moving any further forward by being attached to a front end part of the housing body,
the first component is relatively displaceable in the front-rear direction with respect to the housing body with a front end part of the first component projecting forward from the housing body, and
the second component is moved between the initial position and the connection position integrally with the housing body.

3. The waterproof connector of claim 2, wherein:
the wire is accommodated inside the first component, and
the first component is formed with a detection hole for enabling a part accommodated in the first component, out of the wire, to be visually observed from outside of the housing body.

4. The waterproof connector of claim 1, wherein a movement restricting portion for restricting a relative rearward movement of the terminal fitting is formed in the terminal accommodation chamber.

5. The waterproof connector of claim 1, wherein the flexible connecting portion is formed with a biting portion, the wire biting into the biting portion.

6. The waterproof connector of claim 1, wherein the flexible connecting portion is formed with a compressing portion for sandwiching the wire in a bent state.
